(19) United States
(12) Patent Application Publication
(10) Pub. No.: US 2014/0096048 A1
(43) Pub. Date: Apr. 3, 2014

(54) DRAG AND DROP SEARCHES OF USER INTERFACE OBJECTS

(71) Applicant: HEWLETT-PACKARD DEVELOPMENT COMPANY, L.P., Houston, TX (US)

(72) Inventors: Benjamin Rottler, San Francisco, CA (US); Pilar Strutin-Belinoff, Oakland, CA (US); Greg Arroyo, San Francisco, CA (US)

(73) Assignee: Hewlett-Packard Development Company, L.P., Houston, TX (US)

(21) Appl. No.: 13/629,760

(22) Filed: Sep. 28, 2012

(51) Int. Cl. G06F 3/048; G06F 17/30

(52) U.S. Cl. 715/769

(57) ABSTRACT

Example embodiments relate to drag and drop object searches within a user interface (UI) of a computing device. In example embodiments, a command is received in which a user drags a UI object from an application and drops it onto an area within the UI that is assigned to a search function. In response, a search is performed using the search function based on at least one metadata field associated with the UI object, where the metadata fields used for the search are selected based on an object type of the UI object. Finally, the results of the search are displayed within the UI.

### BACKGROUND

A typical user of a computing device accesses a significant amount of data using the device. For example, a user may locally store documents, emails, calendar events, contact details, music files, videos, and numerous other types of data. In some scenarios, the user may instead store the same data on a cloud server or other remote device and access the data via the Internet or another network connection. The user may then access the various types of data on the device using one or more different applications associated with the data type.

### BRIEF DESCRIPTION OF THE DRAWINGS

The following detailed description references the drawings, wherein:

FIG. 1 is a block diagram of an example computing device for enabling searches based on drag and drop commands applied to user interface (UI) objects within a user interface;

FIG. 2 is a block diagram of an example computing device for enabling drag and drop searches of UI objects based on provision of a data object describing a UI object from an application to an operating system;

FIG. 3 is a flowchart of an example method for enabling searches based on drag and drop commands applied to user interface (UI) objects within a user interface;

FIG. 4 is a flowchart of an example method for enabling drag and drop searches of UI objects based on provision of a data object describing a UI object from an application to a search function via a UI manager of the operating system;

FIG. 5A is a diagram of an example user interface in which a user has dragged a contact object from a contacts application to a search area within the user interface;

FIG. 5B is a diagram of an example user interface in which a user has dragged a contact object from a data sharing application to a search area within the user interface; and

FIG. 5C is a diagram of an example user interface displaying the results of a search performed on a contact UI object.

### DETAILED DESCRIPTION

As detailed above, users of computing devices access data of various types using a number of different applications. Given the large amount of data and number of applications on such devices, it is often difficult for the user to easily find the data he or she desires to access. For example, the device may store documents of different types associated with different applications and the user may be unable to recall which application should be executed to access a given document. The user may encounter similar issues when attempting to access data of other types, such as music, videos, emails, and calendar items.

For these reasons, many computing devices provide a search function that enables the user to search available data sources to locate desired files, applications, or other types of data. For example, some devices include a text-based search that searches file names, program names, and other types of data on the device. Such searches generally perform a search of local data and display relevant results based on the keywords inputted by the user. Another proposed solution enables a user to search using alternative input modalities, such as an image, video, or sketch.

These existing solutions are limited for several reasons. Although some solutions enable multiple types of input for the search, these solutions do not enable a user to perform a search on any object from any application using a simple interaction mechanism. It may therefore be difficult for a user to quickly access data related to a given object, such as an email that is displayed in an email application, a contact displayed in a contacts application, or a photo displayed in a photos application. In addition, existing searches generally do not customize the search input parameters and source data based on the particular type of object provided as input to the search function. As a result, existing searches may not identify the information that is most likely to be helpful to the user.

Example embodiments disclosed herein address these issues by enabling searches to be performed on any type of UI object from any application based on a drag and drop command. In example embodiments, a computing device receives a command by which a UI object currently displayed in an application is dragged from the application and dropped onto an area within the UI that is assigned to a search function. For example, the user may select and drag an email from an email application or contact from a contacts application and then drop the object on a search box within the user interface. In response to the drag and drop command, the search function may then perform a search using data from at least one metadata field associated with the UI object. The metadata field(s) may be selected based on the object type of the UI object, such that the fields used for the search of an email object may be different than the fields used for the search of a contact object. Finally, after performing the search, the results may be displayed within the UI.

In some implementations, when a user drags a UI object from an application, the application may create a data object that stores data related to the UI object. For example, when the application is an email application and the selected object is an email, the application may create a data object that embeds information including the recipient list, email subject, and email text. The application may then provide the data object, including the metadata to be used for the search, to the search function via the operating system.

In this manner, example embodiments enable a user to quickly perform a search by dragging any UI object from any application to a predefined area within the user interface. This enables the user to quickly locate files, applications, and other accessible data that are related to any object contained within the user interface. In addition, because the fields used for the search may be customized depending on the object type, the displayed search results provide useful information for objects of multiple different types.

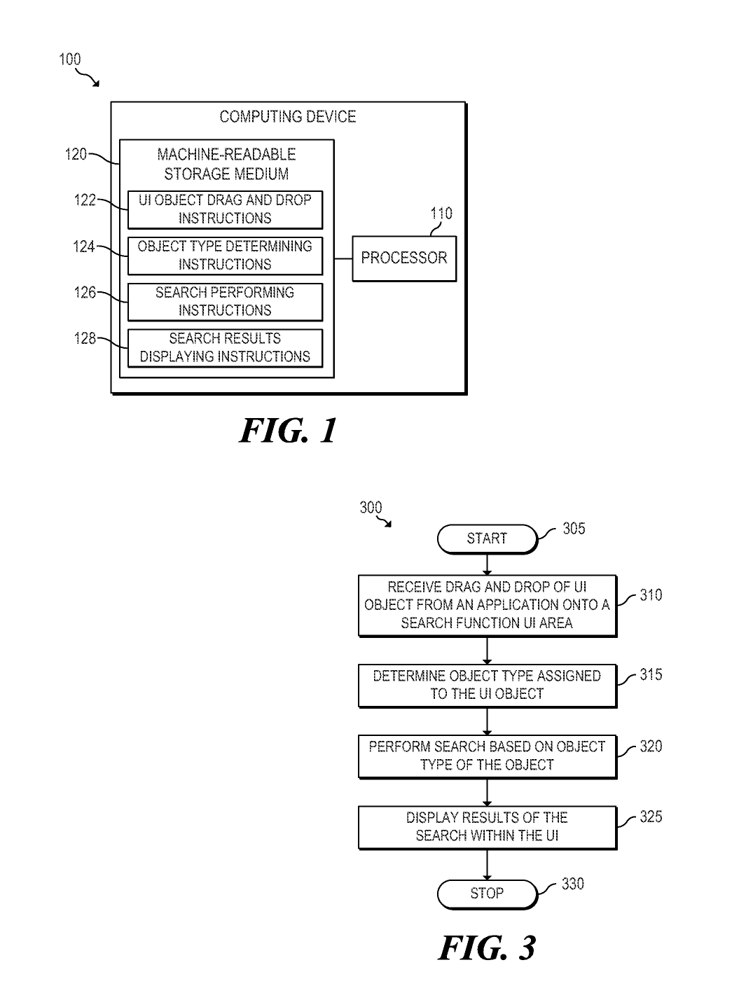

Referring now to the drawings, FIG. 1 is a block diagram of an example computing device 100 for enabling searches based on drag and drop commands applied to user interface objects within a user interface. Computing device 100 may be, for example, a notebook computer, a desktop computer, an all-in-one system, a tablet computing device, an electronic book reader, a mobile phone, a set-top box, or any other computing device suitable for displaying a user interface and receiving user input via the user interface. In the embodiment of FIG. 1, computing device 100 includes a processor 110 and a machine-readable storage medium 120.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 122, 124, 126, 128 to enable a user to perform searches on UI objects that are displayed in applications executing within computing device 100. As an alternative or in addition to retrieving and executing instructions, processor 110 may include one or more electronic circuits that include electronic components for performing the functionality of one or more of instructions 122, 124, 126, 128.

Machine-readable storage medium 120 may be any electronic, magnetic, optical, or other non-transitory physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. As described in detail below, machine-readable storage medium 120 may be encoded with a series of executable instructions 122, 124, 126, 128 for performing searches of UI objects displayed in applications executing on computing device 100.

UI object drag and drop instructions 122 may initially receive a command by which a UI object currently displayed in an application is dragged from the application and dropped onto an area within the UI that is assigned to a search function. For example, computing device 100 may be executing a particular application and the user may move a UI object from the application to the search area by providing input via a touch display, mouse, trackpad, or other input mechanism.

Each of the applications in computing device 100 may comprise instructions executable by processor 110 to enable a user to perform a set of specific tasks. The applications may reside within an operating system (OS) of computing device 100 and call functions provided by the OS to enable the user to perform these tasks. For example, each application may enable the user to communicate with other users, generate or view documents or other files, and/or access data via the Internet or another network. Thus, non-limiting examples of applications for execution in computing device 100 include an email application, messaging application, phone or videoconferencing application, web browser, word processor, contacts application, music or video player, online application catalog, and the like.

In order to enable the user to provide input and receive output via computing device 100, each application may display a number of UI objects with which the user may interact. Each UI object may include a set of visual components outputted on an available display to provide information to a user. For example, the visual components for a given UI object may include visible text, images, UI widgets (e.g., text boxes, scroll bars, selection menus, etc.), or a combination thereof. Accordingly, UI objects are not limited to discrete files stored in a file system of computing device 100; rather, the UI objects may be any visible components that make up a portion of the visual display of an application.

As one set of examples, the UI objects may be discrete visual portions of a given application that may be dislodged from the application and dragged to the search function by the user. For example, when the application is a contacts application for managing contact information of a plurality of contacts, the UI objects may include individual contact records, each associated with a name of the person, an email address, a telephone number, an address, and/or previous communications with the contact. As another example, when the application is an email application, the UI objects may include individual emails, where each email object is a displayed panel that includes a header with address information and a body of the message. Other suitable examples of UI objects will be apparent depending on the particular type of application.

As mentioned above, the user may initialize the search of a UI object by dragging the UI object from the application and onto a search area within the user interface. As one example, the user may simply select the UI object with a touch, mouse click, or other selection input and then drag the UI object outside of the window of the application toward the search area. As another example, the user may first dislodge the UI object from the application by selecting the UI object with a selection input and holding the input for a predetermined duration of time (e.g., 1 second). After the UI object has been dislodged from the application, the user may then drag the object toward the search area and release the UI object on the search area to trigger the search.

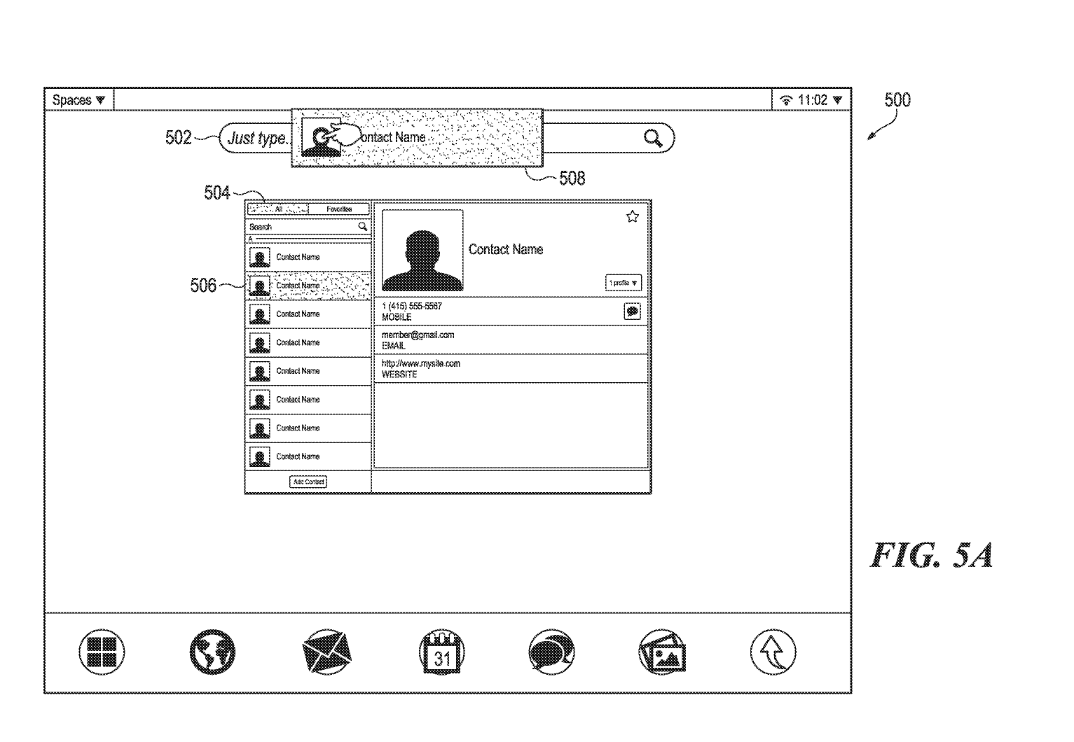

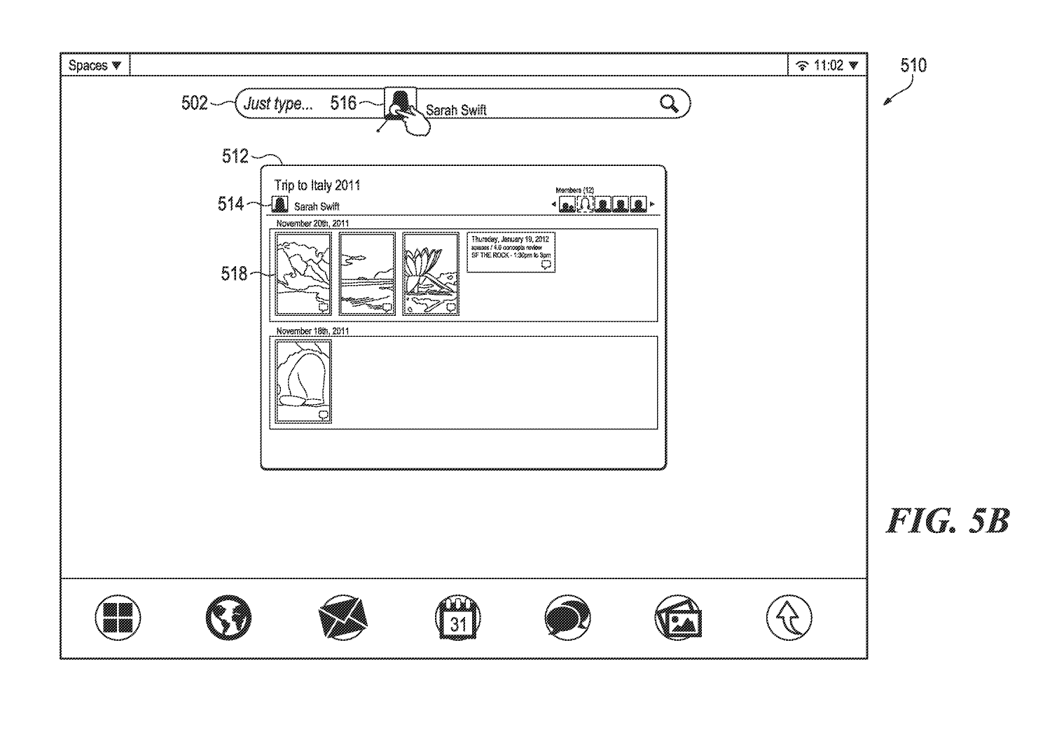

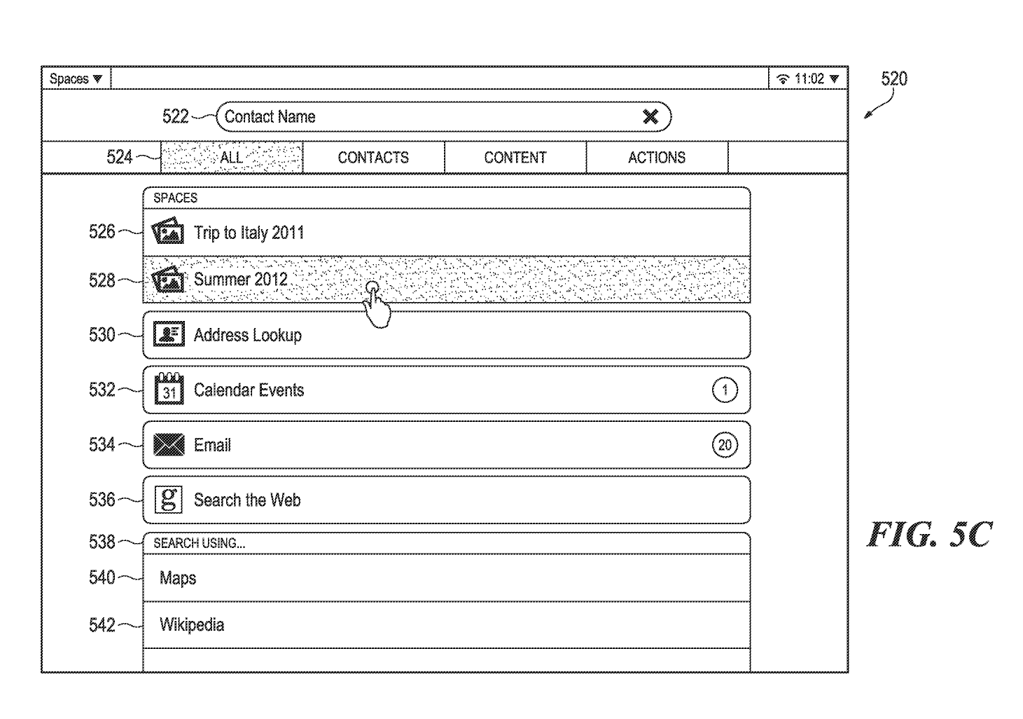

The search area may be any predefined portion of the user interface that is assigned to the search function. In some implementations, the search area may be a fixed section of the home screen of the operating system of device 100, such that the search area remains visible within the operating system. FIGS. 5A & 5B illustrate a particular example in which search area 502 is a rounded rectangle that doubles as a text input box. In these implementations, the search area is on a portion of the home screen that becomes visible when applications executing in the operating system enter a card mode in which the primary application occupies a window of a predetermined size in the center of the UI.

As previously mentioned, the user may trigger the search by dragging a particular UI object from an application and dropping the UI object onto the predefined search area within the UI by, for example, releasing the held input while the object is proximate to the search area. Note that the term “drop” is not limited to implementations in which the user releases the input. Rather, in some implementations, the drop may be automatically triggered in response to the user dragging a UI object into proximity of the search area.

In response to the drag and drop command on a UI object, computing device 100 may then begin the search process. Object type determining instructions 124 may initially determine an object type assigned to the UI object. In some implementations, the UI object may be associated with metadata that describes the object, which may include a specification of the type of the object. For example, the metadata may be stored in a data structure associated with the UI object and may specify whether the UI object is an image, video, email, contact, note, etc. As a specific example, the metadata may be an Extensible Markup Language (XML) data structure that includes a field entitled “type.” Object type determining instructions 124 may determine the type of the UI object by simply extracting the object type from the metadata field.

After determination of the object type, search performing instructions 126 may then perform a search using the search function using data from at least one metadata field associated with the UI object. In some implementations, the metadata field(s) used as input for the search may be selected based on the object type determined by determining instructions 124. For example, search performing instructions 126 may select a subset of the fields included in the metadata for the UI object, where the subset of fields that is selected varies depending on the object type. These fields may be, for example, predetermined fields in an XML data structure or another type of data structure.

As one example, suppose that the UI object received by the search function is a contact object from a contacts application. The metadata for the contact object may include one or more of a name of the person, an email address, a telephone number, a mailing address, and previous communications with the contact (e.g., emails or text messages exchanged with the person). For example, each of these data items may be contained within a corresponding XML tag. Performing instructions 126 may select the metadata fields from the metadata based on the determination that the UI object is a contact object. In particular, performing instructions 126 may select the search parameters as fields from the metadata that correspond to the information specific to the contact, such as the field that stores the person's name, the field that stores the person's email address, etc.

As another example, suppose the UI object received by the search function is an email object from an email application. The metadata for the email object may include, for example, an identification of the sender, an identification of the recipient(s), a subject line, and the email body. In such instances, performing instructions 126 may select the metadata fields from the metadata based on the determination that the UI object is an email object. In particular, performing instructions 126 may select the search parameters as fields from the metadata that correspond to the information specific to the email, such as the field that includes the sender, the field that includes the recipient(s), etc.

In addition to varying the selection of the input data based on the object type, performing instructions 126 may also modify the body of data to be searched based on the object type. The body of data to be searched may be selected from any data accessible to computing device 100 and may therefore include data stored on a local storage device and/or data accessible to device 100 via one or more networks. In some implementations, performing instructions 126 may limit the search to data associated with a subset of applications available on the computing device, where the subset of applications is selected based on the object type. For example, performing instructions 126 may limit the search to data that was created by or is capable of being opened with a given subset of applications.

As one specific example, when the input object is a contact object from a contacts application, performing instructions 126 may limit the body of data to be searched to data objects associated with, for example, the contacts application itself, an email application, and a photos application. In this manner, the search results may be limited to emails, images, and other contacts that match the selected metadata fields associated with the contact UI object. As another example, when the object is an image from a photos application, performing instructions 126 may limit the body of data to be searched to data objects associated with, for example, the photos application and a videos application. In such cases, the search results may be limited to videos and other photos with metadata fields that match the selected metadata fields associated with the photo UI object. In this manner, the data to be searched may be customized for each object type.

After selecting the input parameters and the body of data to be searched, performing instructions 126 may utilize a number of techniques for finding the relevant data stored locally and/or remotely. In some implementations, performing instructions 126 may perform a simple Boolean search that finds all records that match the content of all of the selected metadata fields. For example, in determining whether a particular data object matches the selected metadata fields of the UI object, performing instructions 126 may compare the text contained in each metadata field in the UI object with all metadata fields contained in the particular data record. If the text in each metadata field of the UI object is contained in at least one metadata field of the data object, performing instructions 126 may determine that the data object is a match.

As an alternative to a Boolean “AND” search, performing instructions 126 may perform a Boolean search that finds all records that match the content of one or more of the selected metadata fields (a Boolean “OR” search). In such instances, if the text in at least one metadata field of the UI object is contained in at least one metadata field of the data object, performing instructions 126 may determine that the data object is a match. As yet another example, performing instructions 126 may perform a proximity-type search to locate all records that are of sufficient similarly to the selected metadata fields based, for example, on a dictionary of related keywords. Other suitable algorithms for finding items in the selected body of data that match the selected metadata fields will be apparent.

After search performing instructions 126 have completed the search, search results displaying instructions 128 may then output the results of the search within the user interface. For example, displaying instructions 128 may output a listing of all matching data objects. Each data object in the list may be selectable, such that selecting an item in the list opens the selected data object using the corresponding application.

In some implementations, displaying instructions 128 may output the search results in groups, where each group corresponds to a particular application. For example, as detailed above, search performing instructions 126 may limit the search to data associated with a subset of applications. In such implementations, displaying instructions 128 may display a heading identifying the application and display all matching objects associated with the application in a listing under the heading. Further details regarding an example user interface for displaying search results are provided below in connection with FIG. 5C.

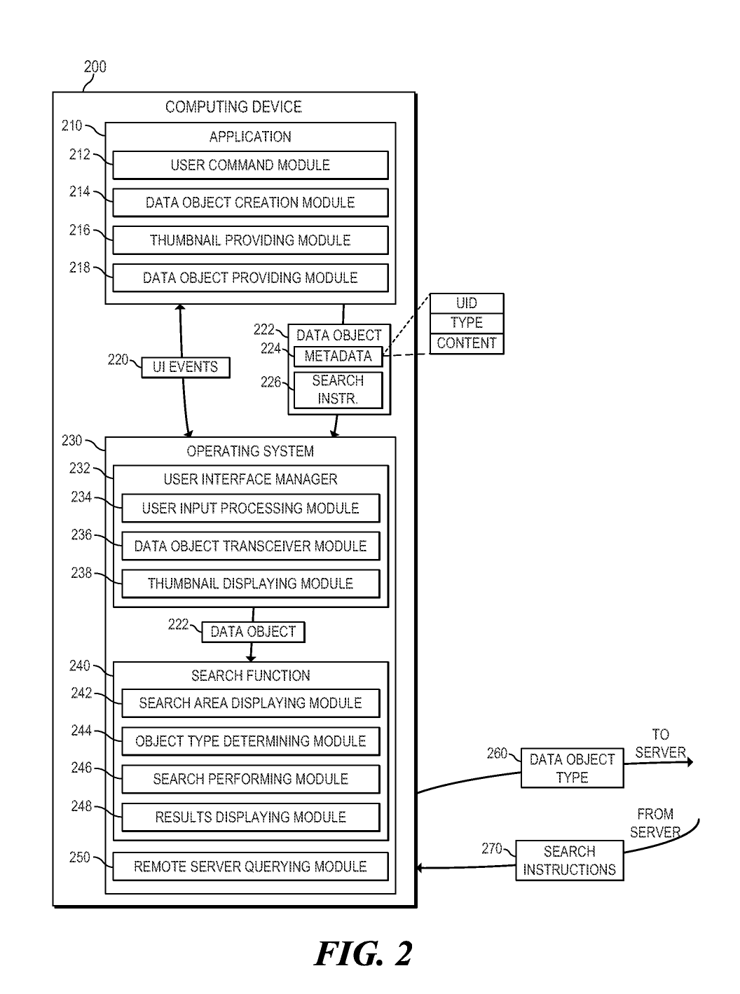

FIG. 2 is a block diagram of an example computing device 200 for enabling drag and drop searches of UI objects based on provision of a data object 222 describing a UI object from an application 210 to an operating system 230. As with computing device 100 of FIG. 1, computing device 200 may be any computing device suitable for displaying a user interface and receiving user input via the user interface.

As illustrated in FIG. 2 and described in detail below, computing device 200 may include a number of modules 210-250. Each of the modules may include a series of instructions encoded on a machine-readable storage medium and executable by a processor of computing device 200. In addition or as an alternative, each module may include one or more hardware devices including electronic circuitry for implementing the functionality described below.

Application 210 may be any set of instructions executable by a processor of computing device 200 to enable a user to perform a set of tasks. Thus, application 210 may output a user interface including a number of UI objects with which the user may interact to perform the set of tasks. In the implementation of FIG. 2, application 210 includes user command module 212, data object creation module 214, thumbnail providing module 216, and data object providing module 218.

User command module 212 may initially receive a user command by which a UI object of a given object type is dragged from the application and dropped onto an area within the UI that is assigned to a search function. For example, user command module 212 may receive a notification of a UI event 220 from UI manager 232 of operating system 230, where the UI event 220 specifies details regarding an input provided by the user (e.g., a touch input, mouse click, etc.). User command module 212 may then determine whether the UI event 220 specifies a user command to initiate a drag of a particular UI object. For example, user command module 212 may determine whether the user has selected and held a particular UI object for a predetermined duration of time, thereby indicating a desire to begin the process for transferring the UI object outside of application 210. As another example, user command module 212 may determine whether the user has selected and dragged a particular UI object outside of the window of application 210. Further details regarding the process for detecting user commands are provided above in connection with UI object drag and drop instructions 122 of FIG. 1.

Upon detection of a user command to drag a particular UI object by user command module 212, data object creation module 214 may then create a data object 222 that maintains data related to the UI object. As detailed below, this object 222 enables the details regarding the UI object to be easily transferred between application 210 and OS 230. Module 214 may, for example, create a set of metadata 224 that includes a unique identifier for the UI object, a type of the UI object, and content of the UI object. Module 214 may also include search instructions 226 in the data object 222, where search instructions 226 specify which fields from metadata 224 should be used when performing a search for an object of the given type.

The metadata 224 included in the data object may be any set of data that describes the particular UI object. For example, the metadata may be a data structure of a predefined format that includes a number of fields, such as an XML data structure. The metadata may store, for example, a unique identifier (UID) that includes a plurality of alphabetic, numeric, and/or symbolic characters. The UID may uniquely identify the particular data object throughout the entire OS 230 of device 200. The metadata may additionally include a data type that specifies the type of UI object (e.g., email, image, video, contact, text message, note, etc.), such that search function 240 can identify the type of object when performing the search. Finally, the metadata may include the data describing the object.

Note that the content included in metadata 224 may vary depending on the type of object and, as detailed below, search function 240 may customize the search for each type of object. For example, the fields in an email may include the sender, recipient(s), subject line, and email content. On the other hand, the fields in a contact object may include the name of the person, email address, telephone number, and/or previous communications with the contact. In some implementations, the data object for a given UI object can also include social networking information that may be used in the search by search function 240. For example, the social networking information may include data generated on a social networking website regarding the UI object, such as comments and expressions of approval (e.g., “likes”, ratings, etc.), and/or a social history of the object (e.g., who originally sent the file corresponding to the UI object to the user of device 200).

Search instructions 226 may identify at least one field from metadata 224 to be used by search function 240 when performing a search for the object. For example, search instructions 226 may include a listing of each metadata field that should be extracted from metadata 224 when performing the search. As a specific example, search instructions 226 may include a list of particular XML tags that should be used for the search. Such implementations are advantageous, as they allow a developer of an application for operating system 230 to define custom search instructions for each object type in their application. Furthermore, in these implementations, search function 240 does not require specific knowledge of each metadata type, as search instructions 226 include information sufficient to enable search function 240 to extract the appropriate metadata fields.

To give a specific example of a data object 222, when application 210 is a contacts application and the UI object is a particular contact, metadata 224 may include a UID for the particular contact, a data type of “contact,” and content describing the contact. Search instructions 226 may identify the metadata fields to be used when performing a search on a contact object, which may include, for example, the name of the person, the person's email address, and the person's phone number. As another example of a data object, when application 210 is an email application and the UI object is a particular email, metadata 224 may include a UID for the particular email, a data type of “email,” and content including the text of the header and email itself. Search instructions 226 may identify the metadata fields to be used when performing a search on the email object, which may include, for example, the sender, recipient(s), subject line, and email body.

In addition to creation of a data object 222 for the UI object by module 214, thumbnail providing module 216 may also create a thumbnail image to represent the UI object. For example, module 216 may generate an image that contains a reduced size preview of the UI object. The image may be, for example, a Joint Photographic Experts Group (JPEG) image, a Graphics Interchange Format (GIF) image, a Portable Network Graphics (PNG) image, or an image encoded according to any other format. Alternatively, the thumbnail image may include a number of UI components at a reduced size (e.g., reduced size text, images, and UI widgets). After generating the thumbnail image of the UI object, thumbnail providing module 216 may then provide the thumbnail to user interface manager 232 of operating system 230 for display by thumbnail displaying module 238.

After creation of the data object 222 by data object creation module 214, data object providing module 218 may then provide the data object 222 to search function 240. As one example, data object providing module 218 may provide the data object 222, including metadata 224 and search instructions 226, to search function 240 via user interface manager 232 of operating system 230.

Operating system 230 may be any set of instructions executable by a processor of computing device 200 to manage the hardware resources of computing device 200 and provide an interface to the hardware to applications running in OS 230, such as application 210. In the implementation of FIG. 2, operating system 230 may include user interface manager 232, search function 240, and remote server querying module 250.

User interface manager 232 may be a component of operating system 230 that controls the user interfaces presented by applications in operating system 230, such as application 210. For example, user interface manager 232 may provide a set of user interface features accessible by application 210 using API function calls. User interface manager 232 may also provide an application runtime environment, such that user interface manager 232 loads application 210 and manages its scheduling and execution. In the implementation of FIG. 2, user interface manager 232 includes user input processing module 234, data object transceiver module 236, and thumbnail displaying module 238.

User input processing module 234 may receive notifications of user input events from operating system 230 and, in response, provide UI event notifications 220 to applications in operating system 230, such as application 210. For example, user input processing module 234 may provide notifications of UI events 220 that describe a type of input (e.g., touch or mouse input), the location of the input (e.g., coordinates on a display of device 200), and any other descriptors of the input (e.g., a duration of a hold of the input). As detailed above, user command module 212 of application 210 may then process the event notifications 220 to determine whether the user has provided a command to drag a UI object from application 210. Alternatively, user input processing module 234 may process the input from the user with reference to the displayed UI objects and directly notify application 210 when the user has provided a command to drag a UI object from application 210.

Data object transceiver module 236 may manage the process for receiving and transmitting data objects 222 between processes within operating system 230, such as application 210 and search function 240. After application 210 has created an object 222, data object transceiver module 236 may receive the data object 222 from application 210. Then, after a release of the UI object on the search area in the UI, data object transceiver module 236 may pass the data object 222 to search function 240. In this manner, data object transceiver module 236 may serve as an operating system intermediary between application 210 and search function 240.

In addition to managing the process for transferring the data object 222 between applications, UI manager 232 may also manage the visualization of the object while the user is dragging the UI object. For example, thumbnail displaying module 238 may initially receive the thumbnail image of the UI object from thumbnail providing module 216 of application 210. Thumbnail displaying module 238 may then display the thumbnail image of the UI object while the UI object is dragged from the window of application 210 to the search area within the user interface.

Search function 240 may be a process executing within operating system 230 for providing drag and drop search functionality to applications, such as application 210. Note that, although search function 240 is illustrated as a component of operating system 230, search function 240 may also be a standalone application executing within operating system 230. In the implementation of FIG. 2, search function 240 includes search area displaying module 242, object type determining module 244, search performing module 246, and results displaying module 248.

Search area displaying module 242 may initially display a user interface element that defines the boundaries of the target area for initiating a search based on a drag and drop command. For example, the search area may be an ellipse, rectangle, or other shape that outlines the drag and drop target area. The search area may also include text and/or image(s) that identify the area as corresponding to a search function. FIGS. 5A & 5B illustrate a particular example in which search area 502 is a rounded rectangle that doubles as a text input box.

When the user triggers the release of a UI object on the displayed search area, object type determining module 244 may initially receive the data object 222 corresponding to the UI object from UI manager 232. As detailed above, data object 222 may include metadata 224 and, in some implementations, search instructions 226. Object type determining module 244 may then determine the type of the UI object by, for example, extracting the object type from metadata 224.

Search performing module 246 may then perform a search using fields from metadata 224 that are selected based on the type of object determined by module 244. In this manner, search performing module 246 may customize the search for each object. Search performing module 246 may initially use one of a number of possible techniques for identifying which fields from metadata 224 should be used for the search.

As a first example technique, search performing module 246 may access a local database that includes search details for each of the object types. For example, the local database may receive an object type as input and, in response, identify the particular metadata fields to be used in the search for the given object type. In such implementations, operating system 230 and/or search function 240 maintain the local database on computing device 200.

As a second example technique, search performing module 246 may identify the metadata fields to be used for the search based on search instructions 226 provided by application 210. For example, as detailed above, the search instructions 226 included in data object 222 may specify which metadata fields should be used by search function 240 in performing a search for the UI object. Thus, search performing module 246 may access search instructions 226 and then extract the metadata fields identified in search instructions 226 from metadata 224.

As a third example technique, search performing module 246 may identify the metadata fields to be used for the search by calling remote server querying module 250. For example, search performing module 246 may provide the object type to querying module 250 and, in response, receive search instructions for the given object type. Search performing module 246 may then extract the appropriate metadata fields from metadata 224 based on the received search instructions. Remote server querying module 250 is described in further detail below.

After identifying the metadata fields to be used as input for the search, search performing module 246 may then identify the data to be searched. As detailed above in connection with search performing instructions 126 of FIG. 1, search performing module 246 may modify the body of data to be searched based on the object type. For example, search performing module 246 may limit the search to data associated with a subset of applications available on the device, where the subset of applications is selected based on the object type. Search performing module 246 may identify these applications using a technique similar to the technique used for identifying the metadata fields. For example, search performing module 246 may identify the applications by querying a local database using the object type, accessing a list of applications in search instructions 226, or by receiving a list of applications in search instructions 270 via querying module 250.

After selecting the input parameters and the body of data to be searched, search performing module 246 may perform the search. Further details regarding example techniques for performing the search using the selected metadata fields are provided above in connection with search performing instructions 126 of FIG. 1.

When search performing module 246 has completed the search, results displaying module 248 may output the results of the search within a user interface in operating system 230. Further details regarding the process for displaying search results are provided above in connection with search results displaying instructions 128 of FIG. 1.

Remote server querying module 250 may be a process executing within operating system 230 or search function 240 to retrieve search instructions 270 for a given object type. For example, as mentioned above, some implementations of search performing module 246 may send an instruction to module to obtain search instructions for a provided object type. In response, querying module 250 may send a query 260 including the object type to a server that maintains a registry of search instructions. Querying module 250 may then receive the search instructions 270 from the server and provide the instructions 270 to search performing module 246 for use in performing the search. Such implementations are advantageous, as application developers may simply register their object types with the central registry to enable customized searches for any UI objects in their applications.

FIG. 3 is a flowchart of an example method 300 for enabling searches based on drag and drop commands applied to user interface (UI) objects within a user interface. Although execution of method 300 is described below with reference to computing device 100 of FIG. 1, other suitable devices for execution of method 300 will be apparent to those of skill in the art (e.g., computing device 200). Method 300 may be implemented in the form of executable instructions stored on a machine-readable storage medium, such as storage medium 120, and/or in the form of electronic circuitry.

Method 300 may start in block 305 and proceed to block 310, where computing device 100 may receive a command to drag a UI object from an application. Computing device 300 may then receive a subsequent command to release the UI object on the search area within the UI.

In response, in block 315, computing device 100 may then determine the object type assigned to the UI object by, for example, extracting the object type from a metadata field associated with the UI object. In block 320, computing device 100 may perform a search based on the object type of the UI object. For example, computing device 100 may select a subset of fields from the metadata based on the object type and perform the search using those selected fields. Finally, in block 325, computing device 100 may output the results of the search. Method 300 may then stop in block 330.

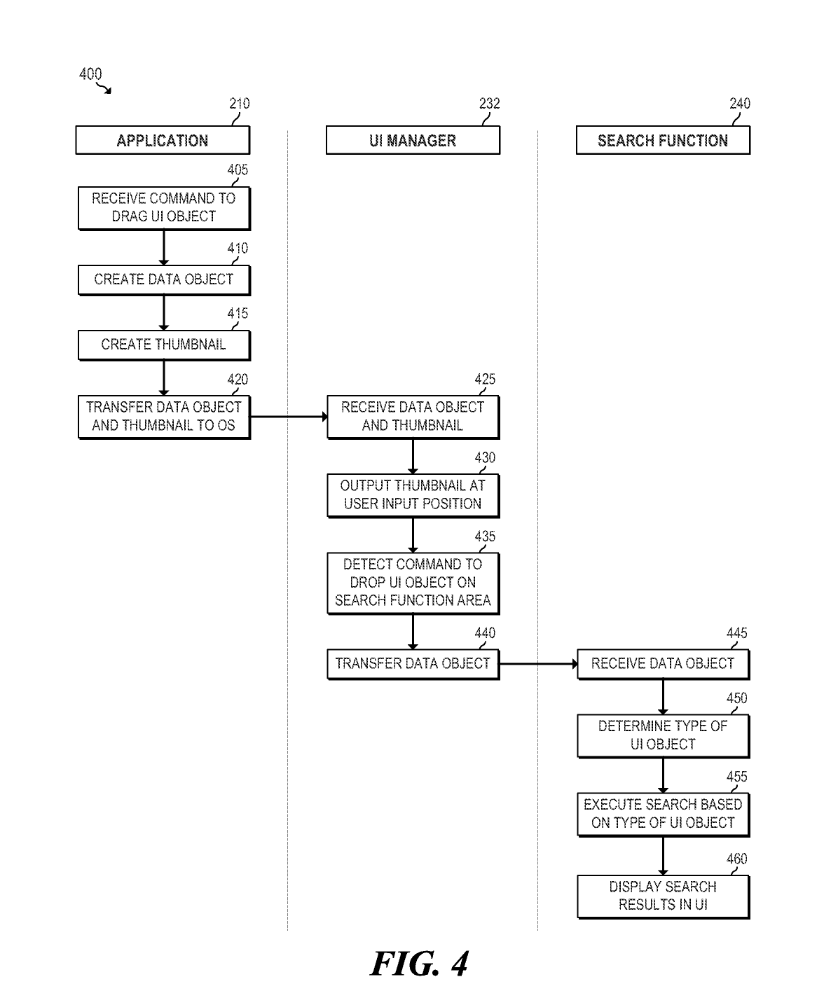

FIG. 4 is a flowchart of an example method 400 for enabling drag and drop searches of UI objects based on provision of a data object describing a UI object from an application 210 to a search function 240 via a UI manager 232 of the operating system 230. Although execution of method 400 is described below with reference to components 210, 232, 240 of computing device 200 of FIG. 2, other suitable components for execution of method 400 will be apparent to those of skill in the art. Method 400 may be implemented in the form of executable instructions stored on a machine-readable storage medium and/or in the form of electronic circuitry.

As illustrated, method 400 may include a number of blocks 405, 410, 415, 420 executed by application 210, a number of blocks 425, 430, 435, 440 executed by UI manager 232, and a number of blocks 445, 450, 455, 460 executed by search function 240. Note that, in some implementations, execution of the blocks of method 400 may be distributed differently between application 210, UI manager 232, and search function 240.

Method 400 may start in block 405, where application 210 may receive a command to drag a UI object from application 210. For example, application 210 may receive a touch input or mouse input that indicates a desire to drag a particular UI object from the application. This input may be, for example, a held selection of the particular UI object for a given period of time or a selection coupled with a drag of the UI object outside of the window of application 210.

Next, in block 410, application 210 may create a data object that stores data related to the UI object. For example, application 210 may create a data structure that stores metadata describing the UI object and search instructions that identify metadata fields to be used when performing a search based on the UI object. In block 415, application 210 may then create a thumbnail image that stores a preview of the content of the UI object to be transferred to the second application. After creating the UI object and thumbnail, application 210 may then, in block 420, transmit the data object and thumbnail to UI manager 232.

Execution of method 400 may then transfer to UI manager 232 when, in block 425, UI manager 232 may receive the data object and thumbnail generated by application 210. In block 430, UI manager 232 may output the thumbnail image of the UI object at the position of the user's input. For example, as the user drags the UI object around the visible display area of computing device 200, UI manager 232 may track the position of the user's input with the thumbnail.

In block 435, UI manager 232 may then detect a drop of the UI object on the search area in the UI. For example, UI manager 232 may determine that the user has released the dragged UI object and, in response, determine whether the position of the released input falls within the area in the UI assigned to the search function. If so, in block 440, UI manager 232 may transfer the data object generated for the UI object to search function 240.

In block 445, search function 240 may receive the data object from UI manager 232, including the metadata and the search instructions. In block 450, search function 240 may identify the object type specified in the data object. For example, search function 240 may extract the “type” field from the metadata included in the data object.

Next, in block 455, search function 240 may execute a search that is customized for the particular object type. For example, search function 240 may initially select the input fields for the search based on search instructions that identify the metadata fields to be used for the search. Search function 240 may then select the body of data to be searched by, for example, restricting the data to be searched to data associated with a subset of applications selected based on the object type. After executing the search with the selected metadata fields on the identified body of data, search function 240 may output the results in block 460.

FIG. 5A is a diagram of an example user interface 500 in which a user has dragged a contact object 506 from a contacts application to a search area 502 within the user interface. As illustrated, user interface 500 includes an application interface 504 displayed by a contacts application that enables a user to view and manage his or her personal contacts.

The interface 504 includes a plurality of individual contacts displayed in a left hand pane of the interface. Because each of the displayed contacts is a separate UI object, the user may drag any of the displayed contacts from the application. In this example, the user has dragged contact 506 from the application. In response, the contacts application has created a thumbnail 508 that is displayed in the user interface as the user drags the contact. As illustrated, the thumbnail 508 is currently hovering over search area 502, such that a release of the input by the user will drop the contact UI object onto the search area 502 and trigger a search of the metadata associated with the UI object.

FIG. 5B is a diagram of an example user interface 510 in which a user has dragged a contact object from a data sharing application to a search area within the user interface. As illustrated, user interface 510 includes an application interface 512 displayed by a data sharing application that enables a plurality of users to share different UI objects with one another.

The interface 512 of the data sharing application includes a plurality of different types of UI objects. For example, interface 512 includes a contact object 514 that identifies an owner of the particular data sharing area, entitled “Trip to Italy.” Interface 512 also includes several photos (e.g., photo 518) and a calendar item. In accordance with this disclosure, each of these objects may be dragged from interface 512 to search area 502 to trigger a search.

In the illustrated example, the user has dragged contact 514 from the application and, in response, the data sharing application has created a thumbnail 516 that is displayed in the user interface as the user drags the contact. The user may simply drop thumbnail 516 onto the search area 502 to trigger a search that is customized for particular fields of the metadata associated with the contact. Note that the user could similarly trigger a search for photo 518 or another UI object in interface 512 by simply dragging and dropping the object.

FIG. 5C is a diagram of an example user interface 520 displaying the results of a search performed on a contact UI object. Interface 520 may be displayed, for example, in response to a search performed on a contact UI object, such as UI object 506 of FIG. 5A or UI object 514 of FIG. 5B. As illustrated, interface 520 includes search area 522 that displays the parameter of the search, which is in this case the name of the contact.

Interface 520 also includes a series of filter buttons 524, each corresponding to a particular type of result. Here, the filter button is set to “All,” such that all types of results are displayed in interface 520. By selecting the other tabs 524, the user could instead limit the results to matching contacts, other content, or actions/applications that may be launched to take an action with respect to the particular contact object.

In addition, interface 520 includes a series of results 526-542. Results 526, 528 correspond to instances of a data sharing application (“Spaces”) that include data related to the particular contact. Result 530 corresponds to an address lookup that may be triggered based on the name of the contact. Result 532 indicates that 1 calendar event was located related to the particular contact, while result 534 indicates that 20 emails were located. Finally, results 536, 538, 540, 542 are action buttons that trigger additional searches for the contact using respective search engines.

The foregoing disclosure describes a number of example embodiments for enabling drag and drop searches of UI objects that are customized for each object. As detailed above, example embodiments allow a user to drag any UI object from any application onto a search area in order to trigger a search for the UI object. In addition, because the fields used for the search may be customized for each object type, the displayed search results provide useful information for each type of object. Additional embodiments and advantages of such embodiments will be apparent to those of skill in the art upon reading and understanding the foregoing description.

We claim:

1. A computing device for enabling drag and drop object searches within a user interface (UI), the computing device comprising:
a processor to:
receive a command by which a UI object currently displayed in an application is dragged from the application and dropped onto an area within the UI that is assigned to a search function;
determine an object type assigned to the UI object;
perform a search using the search function using data from at least one metadata field associated with the UI object, wherein the at least one metadata field used for the search is selected based on the determined object type; and
display results of the search within the UI.

2. The computing device of claim 1, wherein the processor is further to:
create a data object that stores data related to the UI object in response to the command to drag the UI object from the application, wherein data in the data object includes the at least one metadata field; and
provide the data object from the application to the search function for use in performing the search.

3. The computing device of claim 2, wherein the processor is configured to create the data object in response to one of:
a command in which the UI object is selected and held for a predetermined duration; and
a gesture in which the UI object is selected and dragged outside of a window of the application.

4. The computing device of claim 2, wherein:
the data in the data object further comprises search instructions identifying the at least one metadata field to be used in performing a search for the object type; and
the search function utilizes the search instructions to identify the at least one metadata field when performing the search.

5. The computing device of claim 1, wherein the processor is further configured to identify the at least one metadata field to be used for the search by:
querying a server using the determined object type; and
receiving search instructions from the server, wherein the search instructions identify the at least one metadata field to be used for the search.

6. The computing device of claim 1, wherein the processor is further to:
display a thumbnail image of the UI object while the UI object is dragged from the application to the area assigned to the search function.

7. The computing device of claim 1, wherein:
the search function searches data associated with a subset of applications available on the computing device, wherein the subset of applications is selected based on the determined object type; and
the displayed results are outputted in groups, wherein each group corresponds to an application in the subset of applications.

8. The computing device of claim 1, wherein:
the application is a contacts application for managing contact information of a plurality of contacts;
the UI object is an object representing a particular contact; and
the at least one metadata field used in performing the search is one or more of a name of the contact, an email address, a telephone number, an address, and previous communications with the contact.

9. The computing device of claim 1, wherein the at least one metadata field used for the search comprises social networking information comprising at least one of data generated on a social networking website regarding the UI object and a social history of the UI object.

10. A non-transitory machine-readable storage medium encoded with instructions executable by a processor of a computing device for enabling drag and drop object searches within a user interface (UI), the machine-readable storage medium comprising:
instructions for receiving a command by which a UI object of a given object type is dragged from an application and dropped onto an area within the UI that is assigned to a search function;
instructions for performing a search using the search function based on at least one metadata field associated with the UI object, wherein the search function customizes the search for the given object type by selecting the at least one metadata field based on search instructions provided by the application for the given object type; and
instructions for displaying results of the search within the UI.

11. The non-transitory machine-readable storage medium of claim 10, further comprising:
instructions for creating a data object that stores data related to the UI object in response to the command to drag the UI object from the application, wherein the data in the data object includes the at least one metadata field and the search instructions; and
instructions for providing the data object from the application to the search function for use in performing the search

12. The non-transitory machine-readable storage medium of claim 10, wherein the search function searches data associated with a subset of applications available on the computing device, wherein the subset of applications is selected based on the given object type.

13. A method for execution by a computing device for enabling drag and drop object searches within a user interface (UI), the method comprising:
receiving, in the computing device, a command by which a UI object currently displayed in an application is dragged from the application and dropped onto an area within the UI that is assigned to a search function;
creating, by the application, a data object that stores data related to the UI object in response to the command to drag the UI object from the application, wherein the data object includes a plurality of metadata fields describing the UI object;
providing the data object from the application to an operating system of the computing device;
performing a search using the search function based on at least one of the metadata fields in the data object, wherein the at least one metadata field used for the search is selected based on an object type of the UI object; and
displaying results of the search within the UI.

14. The method of claim 13, wherein:
the created data object further includes search instructions identifying the at least one metadata field to be used in performing the search; and
the search function accesses the search instructions in the data object to identify the at least one metadata field to be used for the search.

15. The method of claim 13, wherein providing the data object from the application to the operating system comprises:
providing the data object from the application to a user interface manager of the operating system; and
providing the data object from the user interface manager of the operating system to the search function.
